(19) United States
(12) Patent Application Publication
(10) Pub. No.: US 2014/0329162 A1
(43) Pub. Date: Nov. 6, 2014

(54) MEMBRANE ELECTRODE ASSEMBLY FOR FUEL CELL

(71) Applicant: Hyundai Motor Company, Seoul (KR)

(72) Inventors: Young Taek Kim, Seoul (KR); Inchul Hwang, Seongnam (KR); Nak Hyun Kwon, Seoul (KR); Ju Ho Lee, Incheon (KR); Sang-Uk Kim, Incheon (KR); Jin-Young Kim, Incheon (KR); Dong Il Kim, Incheon (KR); Chang-Hyeong Lee, Incheon (KR)

(73) Assignee: HYUNDAI MOTOR COMPANY, Seoul (KR)

(21) Appl. No.: 14/102,089

(22) Filed: Dec. 10, 2013

(30) Foreign Application Priority Data
May 2, 2013 (KR) 10-2013-0049544

(51) Int. Cl. H01M 8/02; H01M 8/24; H01M 8/10

(52) U.S. Cl. CPC H01M 8/0273; H01M 8/1004; H01M 8/2465
USPC 429/463; 429/479; 429/480; 429/494; 429/492; 429/493

(57) ABSTRACT

A membrane electrode assembly for a fuel cell is provided that includes a membrane, electrodes on both sides of the membrane, respectively, and sub-gaskets bonded to the edges of the electrodes, respectively. In particular, the sub-gasket may be bonded to the membrane at a predetermined distance from the edge of the electrode.

### CROSS-REFERENCE TO RELATED APPLICATION

This application claims priority to and the benefit of Korean Patent Application No. 10-2013-0049544 filed in the Korean Intellectual Property Office on May 2, 2013, the entire contents of which are incorporated herein by reference.

### BACKGROUND OF THE INVENTION

(a) Field of the Invention

An exemplary embodiment of the present invention relates to a fuel cell. More particularly, the present invention relates to a membrane electrode assembly (MEA) for a fuel cell.

(b) Description of the Related Art

Fuel cells generate electric energy by electrochemically reacting a fuel (e.g., hydrogen) and an oxidant (e.g., air) together. As such, fuel cells have a characteristic in that they can continuously generate electricity by inputting chemical reactants into the system. Furthermore, fuel cells can be classified into polymer electrolyte membrane fuel cells, a phosphoric acid fuel cells, a molten carbonate fuel cells, a solid oxide fuel cells, and an alkaline fuel cells.

The polymer electrolyte membrane fuel cell (PEMFC), in particular, has a characteristic that the operation temperature is lower, the efficiency is higher, the current density and output density is greater, the start/stop time is shorter, and the response to a load changes is quicker, in comparison to other types of fuel cells.

Fuel cells may be implemented by disposing a separator (e.g., a separating plate or a bipolar plate) on both sides with an MEA (Membrane Electrode Assembly) therebetween. The MEA generates electricity through oxidation/reduction reaction of fuel (e.g., hydrogen) and an oxidant (e.g., oxygen) and is thus of the power generation source of the polymer electrolyte membrane fuel cell. MEAs may be fabricated in two ways of a CCM (Catalyst Coated Membrane) and a CCG (Catalyst Coated GDL).

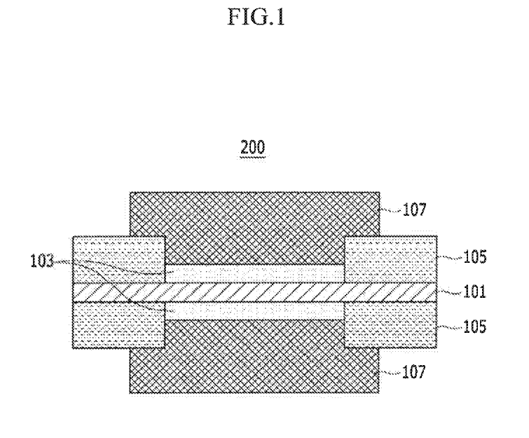

FIG. 1 is a schematic view showing a cross-section of a membrane electrode assembly that is used in a common polymer electrolyte membrane fuel cell. Referring to FIG. 1, in a membrane electrode assembly 200, a fuel electrode and an oxidizing electrode, which are electrodes 103, are formed at both sides from a membrane 101 through which fuel ions move. The membrane electrode assembly 200 includes a sub-gasket 105 protecting the electrodes 103 and the membrane 101 and ensuring a good assembly characteristic of the fuel cell.

A GDL (Gas Diffusion Layer) 107 diffusing the reaction gas in this case of hydrogen and oxygen is integrally bonded to the electrodes 103 of the membrane electrode assembly 200. The GDL 107 may be integrally bonded to a portion of the sub-gasket 105 and the entire surfaces of the electrodes 103.

One of the main concerns in developing the sub-gasket 105 for the membrane electrode assembly 200 is to prevent leakage of a reaction gas, increase the cell output performance.

One common shape of the sub-gasket 105 for the membrane electrode assembly 200 for a fuel cell overlaps or comes in contact with a predetermined area of the electrodes 103. This portion where the membrane 101 and the electrodes 103 are in contact is often at a sharp right angle.

However, according to this structure, when membrane electrode assembly or the membrane moves in the thickness or width direction and stress due to contraction/expansion is applied thereto. This movement often occurs during repeatedly drying/humidifying the membrane or when r a difference in pressure is generated between a hydrogen electrode and an air electrode while the membrane electrode assembly is being operated.

The membrane electrode assembly or the membrane contracts and expands by about 1-50% in the thickness and width directions due to humidifying. As such, a small amount of stress is concentrated on the edge of the sub-gasket due to the contraction and expansion of the membrane electrode assembly and the membrane. Therefore, fatigue failure is likely to be generated at a portion of the membrane where the electrodes of the membrane electrode assembly and the sub-gasket are in contact, and the portion therefore becomes easily torn.

In addition, the electrode transferred to the membrane is different in moisture content from the membrane and has different contract/expansion ratio, under the same humidifying environment. Therefore, a small amount of stress continuously concentrates on the boundary line between the membrane and the electrode under a continuous drying/humidifying environment, and the stress increases, when they overlap the edge of the sub-gasket, so that the interface of the electrode may be easily cut.

The above information disclosed in this Background section is only for enhancement of understanding of the background of the invention and therefore it may contain information that does not form the prior art that is already known this country to a person of ordinary skill in the art.

### SUMMARY OF THE INVENTION

The present invention has been made in an effort to provide a membrane electrode assembly for a fuel cell whcih is able to prevent fatigue failure due to movement of a membrane by reducing a concentration of stress on the membrane, where an electrode and a sub-gasket are in contact, by movement of the membrane due to repeatedly drying/humidifying or a pressure difference between a hydrogen electrode and an air electrode.

An exemplary embodiment of the present invention provides a membrane electrode assembly for a fuel cell that includes a membrane, electrodes on both sides of the membrane, respectively, and sub-gaskets bonded to the edges of the electrodes, respectively. In particular, the sub-gasket may be bonded to the membrane at a predetermined distance from an edge of the electrode in order to reduce a stress concentration on the membrane.

In the membrane electrode assembly for a fuel cell according to an exemplary embodiment of the present invention, a buffer space satisfying 0.5% or more of an area of the electrode may be defined between the edge of the electrode and an edge of the sub-gasket. Alternatively, the buffer space may be a gap satisfying about 0.5-10% of the area of the electrode, and more preferably the buffer space may be a gap satisfying about 8% of the area of the electrode. This buffer space may be a space closed by the gas diffusion layer and the sub-gasket. Furthermore, in the membrane electrode assembly for a fuel cell according to an exemplary embodiment of the present invention, a gas diffusion layer overlapping the edge of the sub-gasket may be bonded to the electrode as well.

In the membrane electrode assembly for a fuel cell according to an exemplary embodiment of the present invention, the membrane may be selected from a group of a perfluorinated sulfonic acid group-containing polymer, a perfluoro-based proton conductive polymer membrane, a sulfonated polysulfone copolymer, a sulfonated poly(ether-ketone)-based copolymer, a sulfonated polyether ether ketone-based polymer, a polyimide-based polymer, a polystyrene-based polymer, a polysulone-based polymer, and a clay-sulfonated polysulfone nanocomposite, and a compound of them.

Advantageously, according to an exemplary embodiment of the present invention, it is possible to further improve the mechanical properties and durability of the membrane electrode assembly during a drying/humidifying condition by defining a buffer space between an electrode and a sub-gasket.

BRIEF DESCRIPTION OF THE DRAWINGS

The drawings are provided for reference in describing exemplary embodiments of the present invention and the spirit of the present invention should not be construed only by the accompanying drawings.

FIG. 1 is a schematic view showing a cross-section of a membrane-electrode assembly that is used in a conventional polymer electrolyte membrane fuel cell.

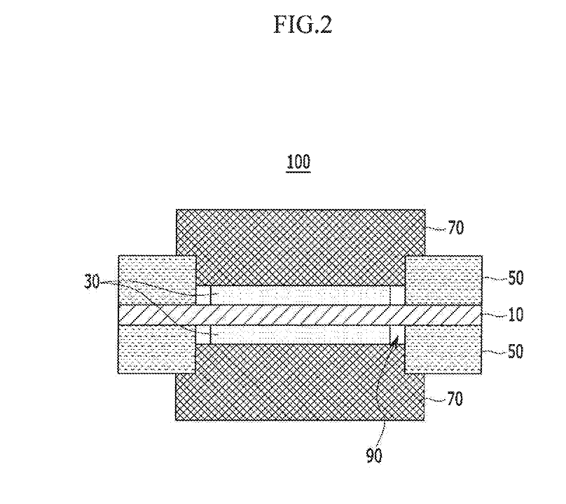

FIG. 2 is a schematic view showing a cross-section of a membrane electrode assembly for a fuel cell according to an exemplary embodiment of the present invention.

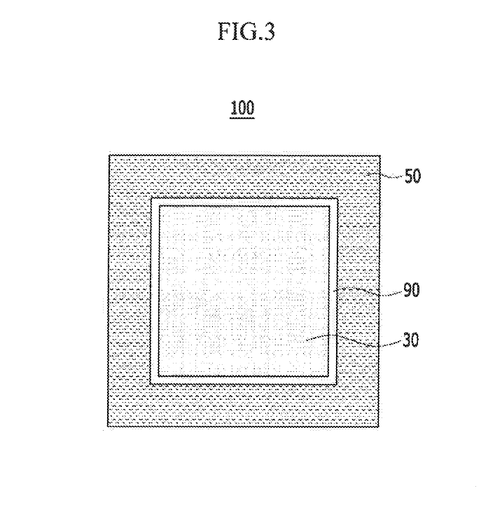

FIG. 3 is a schematic view showing the front of the membrane electrode assembly for a fuel cell according to an exemplary embodiment of the present invention.

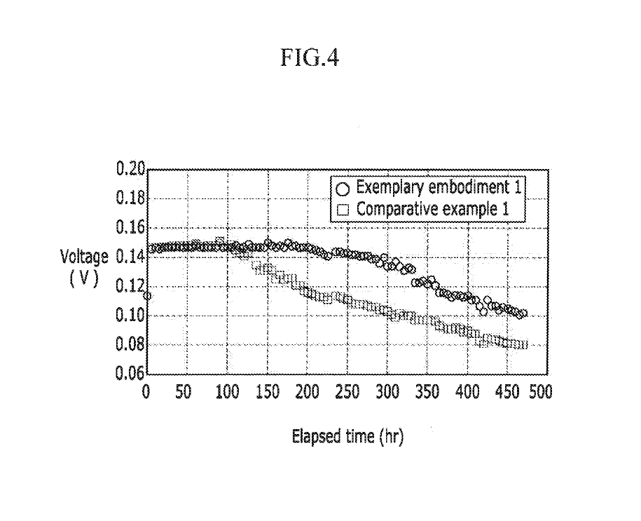

FIG. 4 is a graph showing changes in voltage to time due to repetitive drying/humidifying of the membrane electrode assemblies according to a comparative example and an exemplary embodiment of the present invention.

### DETAILED DESCRIPTION OF THE EMBODIMENTS

Hereinafter, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The unrelated parts to the description of the exemplary embodiments are not shown to make the description clear and like reference numerals designate like element throughout the e specification.

Further, the sizes and thicknesses of the configurations shown in the drawings are provided selectively for the convenience of description, so that the present invention is not limited to those shown in the drawings and the thicknesses are exaggerated to make some parts and regions clear.

Discriminating the names of components with the first, the second, etc, in the following description is for discriminating them for the same relationship of the components and the components are not limited to the order in the following description.

Throughout the specification, unless explicitly described to the contrary, the word “comprise” and variations such as “comprises” or “comprising” will be understood to imply the inclusion of stated elements but not the exclusion of any other elements.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

FIG. 2 is a schematic view showing a cross-section of a membrane electrode assembly for a fuel cell according to an exemplary embodiment of the present invention and FIG. 3 is a schematic view showing the front of the membrane electrode assembly for a fuel cell according to an exemplary embodiment of the present invention.

Referring to FIGS. 2 and 3, a membrane electrode assembly 100 according to an exemplary embodiment of the present invention, which generates electricity using oxidation/reduction reaction of hydrogen and oxygen, may be available for a polymer electrolyte membrane fuel cell (PEMFC). The membrane electrode assembly 100 includes basically a membrane 10, electrodes 30 of a hydrogen electrode and an air electrode formed on both sides of the membrane 10, respectively, and sub-gaskets 50 being in contact with the ends of the electrodes 30.

The membrane 10, through which hydrogen (or any other fuel) ions move, may include a perfluoro-based proton conductive polymer membrane, a sulfonated polysulfone copolymer, a hydrocarbon-based polymer represented by sulfonated poly(ether-ketone) base, a perfluorinated sulfonic acid group-containing polymer, and at least one ion conductive polymer selected from the group of a sulfonated polyether ether ketone base, a polyimide base, a polystyrene base, a polysulfone base, and a clay-sulfonated polysulfone nanocomposite. Furthermore, the electrode 30, which causes oxidation and reduction reaction of hydrogen and oxygen, may be made of a catalyst produced by technologies well known in the art.

The sub-gaskets 50, for protecting the electrodes 30 and the membrane 10 and ensuring good assembly characteristics of a fuel cell, are bonded to both sides of the membrane 10, respectively, with the electrodes 30 exposed. The bonding structure of the sub-gasket 50 will be described in detail below.

A gas diffusion layer (GM) 70 diffusing the reaction gas of hydrogen (or any other fuel) and oxygen is integrally bonded to the electrodes 30 on both sides of the membrane 10. The gas diffusion layer 70 may be integrally bonded to a portion of the sub-gasket 50 and the entire surfaces of the electrodes 30 in the exemplary embodiment of the present invention.

The membrane electrode assembly 100 according to an exemplary embodiment of the present invention described above has a structure that can prevent fatigue failure due to movement of the membrane 10 while reducing concentration of stress on the membrane 10, where the electrodes 30 and the sub-gaskets 50 are in contact, by movement of the membrane 10 due to repeatedly drying/humidifying the membrane or a difference in pressure between the hydrogen electrode and the air electrode.

That is, an exemplary embodiment of the present invention provides the membrane electrode assembly 100 for a fuel cell that can prevent the membrane 10 from being torn at the portion where the sub-gaskets 50 and the electrodes 30 are in contact, under a repetitive drying/humidifying environment. To this end, the sub-gasket 50 may be bonded to the membrane 10 at a predetermined distance from the edge of the electrode 30.

Accordingly, a buffer space 90 satisfying e.g., 0.5% or more of the area of an electrode 30 is defined between the edge of the electrode 30 and the edge of the sub-gasket 50. More specifically, the buffer space 90 may be a gap satisfying 0.5-10% of the area of the electrode 30. For example, the buffer space 90 may be a gap satisfying 8% of the area of the electrode 30.

It is the most preferable that the buffer space 90 is 0.5%-10% of the area of the electrode 30, as described above, but when the buffer space 90 is 10% or more, it may be larger than the space of a rubber gasket (not shown), depending on the area of the electrode 30, such that the reaction gas may leak therethrough. Thus, it is advantageous to make the buffer space 90 smaller than the rubber gasket preventing leakage of the reaction gas, in terms of fabricating a cell and a stack while still maintaining the performance of the cell.

On the other hand, as described above, the gas diffusion layer 70 is bonded to the electrode 30, in which the gas diffusion layer 70 may be bonded to the electrode 30 while overlapping the edge of the sub-gasket 50. Accordingly, the buffer space 90 may be a space closed by the gas diffusion layer 70 and the sub-gasket 50.

The present invention is described in more detail hereafter with reference to the following exemplary embodiments. However, the following exemplary embodiments are only for exemplifying the present invention and the present invention is not limited thereto.

Membrane electrode assemblies according to Exemplary embodiment 1 and Comparative example 1 were fabricated and the performance was tested, as follows, in order to compare the performance of the membrane electrode assembly 100 according to an exemplary embodiment of the present invention and a membrane electrode assembly 200 (see FIG. 1) of the related art.

### EXEMPLARY EMBODIMENT 1

A film coated with an electrode was cut in 25 cm², an electrode transfer film was overlapped on a DM (Dongjin, thickness of 25 μm) hydrocarbon-based film, which is a polymer. membrane, and the electrode transfer film was transferred on the membrane by thermal pressing for 5 minutes at 140° C. and 30 kgf/cm². Thereafter, a sub-gasket that is 8% of the area of the electrode was ensured to ensure a buffer space of the membrane and a sub-gasket of 5.2×5.2 cm² was cut.

The sub-gasket was overlapped on the membrane with the electrode transferred and then a membrane electrode assembly was fabricated by thermal pressing for 1 minute at 100° C.

### COMPARATIVE EXAMPLE 1

A membrane with an electrode transferred is prepared in the same way as the Exemplary embodiment 1. A sub-gasket having the same size of 5×5 cm² as the area of the electrode was cut, the electrode and the sub-gasket were overlapped, and a membrane electrode assembly without a buffer space was fabricated by thermal pressing for 1 minute at 100° C.

Evaluation Process

In order to test the performance of the unit cells including the membrane electrode assemblies fabricated by Exemplary embodiment 1 and Comparative example 1, the unit cells were assembled with gas diffusion layers (SGL 10BB, common GDL, SGL Carbon Group) close to both sides, respectively, of the membrane electrode assemblies.

Changes in open circuit voltage (OCV) were monitored in real time while continuously and repetitively changing humidifying and drying at intervals of 20 minutes and 10 minutes, with the temperatures at the inlet of a hydrogen electrode and the inlet of an air electrode maintained at 85° C., 90° C., and 90° C., respectively, the difference between the pressure and the atmospheric pressure maintained at 0 psi, and the flow rate maintained at 1 L/min at the hydrogen electrode and the air electrode.

Table 1 shows the OCV reduction ratio in the fuel cells fabricated by Exemplary embodiment 1 and Comparative example 1.

TABLE 1

| | Operation | Voltage (V) | Voltage (V) | Voltage |
|---|---|---|---|---|
| | time | before | after | reduction |
| Items | (Hr) | evaluation | evaluation | rate (%) |
| Exemplary | 470 | 0.147 | 0.102 | 31% |
| embodiment 1 | | | | |
| Comparative | 470 | 0.147 | 0.080 | 46% |
| example 1 | | | | |

FIG. 4 is a graph showing the result of measuring OCV in a durability test of the unit cells including the membrane electrode assemblies according to Exemplary embodiment 1 and Comparative example 1, under the conditions described above, Referring to Table 1 and FIG. 4, it can be seen that OCV in Exemplary embodiment 1 was maintained uniformly longer than OCV in Comparative example 1.

Further, it was found from the graph shown in FIG. 4 that the membrane electrode assembly with a buffer space can maintain OCV stably longer than the membrane electrode assembly of the related art, by increasing the mechanical durability, under a drying/humidifying environment. On the other hand, it was also found that the mechanical durability of the membrane electrode assembly without a buffer space was decreased due to easy breaking of the interface of the electrodes in the durability acceleration test.

In other words, in Comparative example 1, non-uniform stress concentration is likely to be generated in the interface between the electrodes and the membrane due to different contraction/expansion rates of the electrodes and the membranes under the drying/humidifying conditions. That is, when the membrane electrode assembly is fabricated with the sub-gasket in contact with the electrode, stress concentration is increased due to non-uniform contraction and expansion between the electrode and the membrane.

Accordingly, in the membrane electrode assembly of Exemplary embodiment 1, it is possible to attenuate stress concentration due to the sharp edge of the sub-gasket and the non-uniform contraction/expansion between the electrode and the membrane, by forming a buffer surface between the electrode and the sub-gasket. That is, the membrane electrode assembly with a buffer space provided between the electrode and the sub-gasket increases improves the mechanical properties of the cell more than the membrane electrode assembly of Comparative example 1 in which the sub-gasket and the electrode are in contact or overlapped.

According to the membrane electrode assembly 100 for a fuel cell according to an exemplary embodiment of the present invention, which was described above, a buffer space 90 satisfying 0.5% or more of the area of the electrode 30 is included between the electrode 30 and the sub-gasket 50. As such, in an exemplary embodiment of the present invention, it is possible to prevent fatigue failure due to flow of the membrane 10 by attenuating stress concentration in the membrane 10, where the electrode 30 and the sub-gasket 50 are in contact, which is caused by the movement of the membrane due to repeatedly drying/humidifying the membrane or a pressure difference between the hydrogen electrode and the air electrode.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

10 . . . Membrane
30 . . . Electrode
50 . . . Sub-gasket
70 . . . Gas diffusion layer
90 . . . Buffer space

What is claimed is:

1. A membrane electrode assembly for a fuel cell including:
a membrane:
electrodes on both sides of the membrane, respectively: and
sub-gaskets in contact with edges of the electrodes, respectively, wherein the sub-gaskets are bonded to the membrane at a predetermined distance from the edges of the electrodes.

2. The assembly of claim 1, wherein a buffer space satisfying 0.5% or more of an area of each electrode is defined between edges of the electrodes and edges of the sub-gaskets.

3. The assembly of claim 2, wherein the buffer space is a gap satisfying 0.5-10% of the area of each electrode.

4. The assembly of claim 3, wherein the buffer space is a gap satisfying 8% of the area of each electrode.

5. The assembly of claim 2, wherein
gas diffusion layers overlapping the edges of the sub-gaskets is bonded to the electrodes, and
the buffer space is enclosed by the gas diffusion layer and one of the sub-gaskets.

6. The assembly of claim 1, wherein the membrane is selected from a group of a perfluorinated sulfonic acid group-containing polymer, a perfluoro-based proton conductive polymer membrane, a sulfonated polysulfone copolymer, a sulfonated poly(ether-ketone)-based copolymer, a sulfonated polyether ether ketone-based polymer, a polyimide-based polymer, a polystyrene-based polymer, a polysulone-based polymer, and a clay-sulfonated polysulfone nanocomposite, and a compound of them

7. A fuel cell stack including a plurality of fuel cells, each fuel cell of the fuel cell stack comprising:
a membrane electrode assembly for a fuel cell including:
a membrane:
electrodes on both sides of the membrane, respectively: and
sub-gaskets in contact with edges of the electrodes, respectively, wherein the sub-gaskets are bonded to the membrane at a predetermined distance from the edges of the electrodes.

8. The fuel cell stack of claim 7, wherein a buffer space satisfying 0.5% or more of an area of each electrode is defined between edges of the electrodes and edges of the sub-gaskets.

9. The fuel cell stack of claim 8, wherein the buffer space is a gap satisfying 0.5-10% of the area of each electrode.

10. The fuel cell stack of claim 9, wherein the buffer space is a gap satisfying 8% of the area of each electrode.

11. The fuel cell stack of claim 8, wherein
gas diffusion layers overlapping the edges of the sub-gaskets is bonded to the electrodes, and
the buffer space is enclosed by the gas diffusion layer and one of the sub-gaskets.

12. The fuel cell stack of claim 7, wherein the membrane is selected from a group of a perfluorinated sulfonic acid group-containing polymer, a perfluoro-based proton conductive polymer membrane, a sulfonated polysulfone copolymer, a sulfonated poly(ether-ketone)-based copolymer, a sulfonated polyether ether ketone-based polymer, a polyimide-based polymer, a polystyrene-based polymer, a polysulone-based polymer, and a clay-sulfonated polysulfone nanocomposite, and a compound of them
